(19) United States
(12) Patent Application Publication
(10) Pub. No.: US 2012/0129111 A1
(43) Pub. Date: May 24, 2012

(54) PREMIX FOR NON-GASEOUS FUEL DELIVERY

(75) Inventors: Thomas F. Robertson, Medina Township, OH (US); John J. Nowakowski, Valley View, OH (US); Bruce E. Cain, Akron, OH (US)

(73) Assignee: Fives North America Combustion, Inc., Cleveland, OH (US)

(21) Appl. No.: 13/109,235

(22) Filed: May 17, 2011

Related U.S. Application Data
(60) Provisional application No. 61/347,153, filed on May 21, 2010.

(51) Int. Cl. F23C 1/04; F23L 9/00; F27B 13/02; F23C 5/08; F23K 3/02

(52) U.S. Cl. 431/9; 431/12; 432/166; 432/1; 431/278

(57) ABSTRACT

A method of combusting non-gaseous fuel to heat a load in a process chamber includes the steps of injecting reactant streams into a combustion chamber. The combustion chamber does not contain a load to be heated, but communicates with the process chamber through a burner port. A first reactant stream includes the non-gaseous fuel, and is injected into the combustion chamber to cause the non-gaseous fuel to volatilize in the combustion chamber. A second reactant stream, which includes a premix of gaseous fuel and primary oxidant, also is injected into the combustion chamber. The first and second reactant streams then combust together to yield products of combustion that flow through the burner port from the combustion chamber to the process chamber. Importantly, the second reactant stream is injected into the combustion chamber adjacent to the first reactant stream. This causes the second reactant stream to adjoin the first reactant stream at the onset of volatilization of the non-gaseous fuel, which is found to inhibit the production of NOx.

### RELATED APPLICATIONS

This application claims the benefit of provisional U.S. Patent Application 61/347,153, filed May 21, 2010, which is incorporated by reference.

### TECHNICAL FIELD

This technology relates to the combustion of non-gaseous fuel for heating a load in a process chamber.

### BACKGROUND

Non-gaseous fuels frequently contain nitrogen. Burning such fuels using traditional methods results in a large portion of the fuel-bound nitrogen combining with oxygen to form nitrogen oxides (NOx). NOx is a regulated air emission since it can have negative effects on people and/or lead to photochemical smog.

The initial stages of solid fuel combustion require the addition of heat to release volatile matter from the solid particle, called devolatilization. The terms devolatilization and volatilization may generally be used interchangeably in this context. Volatile matter may be either light molecular weight species which are gaseous at room temperature or tars which are liquid at room temperature. Increasing the initial heating rate of the solid fuel accelerates the devolatilization process. In the prior art the initial heating rate has been increased by using either substantially pure oxygen or oxygen-enriched combustion air which reduces fuel NOx but increases thermal NOx.

Traditional approaches to mitigation of fuel NOx have centered on spatially staging the combustion air to delay mixing, such that few oxygen radicals are available, and thus the nitrogen radicals produced predominantly combine with each other. Spatially staging the combustion air to delay mixing requires the fabrication of large, expensive structures for segmenting and subsequently delivering the combustion air.

In the combustion of solid fuels in the prior art, the solid fuel is injected into a combustion zone in one or more streams of conveyance air. Combustion air is introduced into the combustion zone in one or more streams that are adjacent to and/or intersect with the streams of solid fuel and conveyance air. The inventors have observed that introducing air in this manner creates a region of locally high oxygen concentration, which favors the creation of NOx.

### SUMMARY OF THE INVENTION

The invention provides a method of combusting non-gaseous fuel to heat a load in a process chamber. The method includes the steps of injecting reactant streams into a combustion chamber. The combustion chamber does not contain a load to be heated, but communicates with the process chamber through a burner port. A first reactant stream includes the non-gaseous fuel, and is injected into the combustion chamber to cause the non-gaseous fuel to volatilize in the combustion chamber. A second reactant stream, which includes a premix of gaseous fuel and primary oxidant, is injected into the combustion chamber adjacent to the first reactant stream. This causes the second reactant stream to adjoin the first reactant stream at the onset of volatilization of the non-gaseous fuel. The first and second reactant streams then combust together to yield products of combustion that flow through the burner port from the combustion chamber to the process chamber. Causing the premix stream to adjoin the non-gaseous fuel stream at the onset of volatilization of the non-gaseous fuel is found to help inhibit the production of NOx.

In a preferred mode of the method, a reactant stream of secondary oxidant is injected into the process chamber from a port that is spaced from the burner port. This further helps to inhibit the production of NOx by separating the non-gaseous fuel from the stream of secondary oxidant until the volatilization of the non-gaseous fuel is complete or nearly complete.

### BRIEF DESCRIPTION OF THE DRAWINGS

FIG. 1 is a schematic view of parts of a boiler.

FIG. 2 is a view taken on line 2-2 of FIG. 1, showing additional parts of the boiler.

FIG. 3 is a view taken on line 3-3 of FIG. 1, showing additional parts of the boiler.

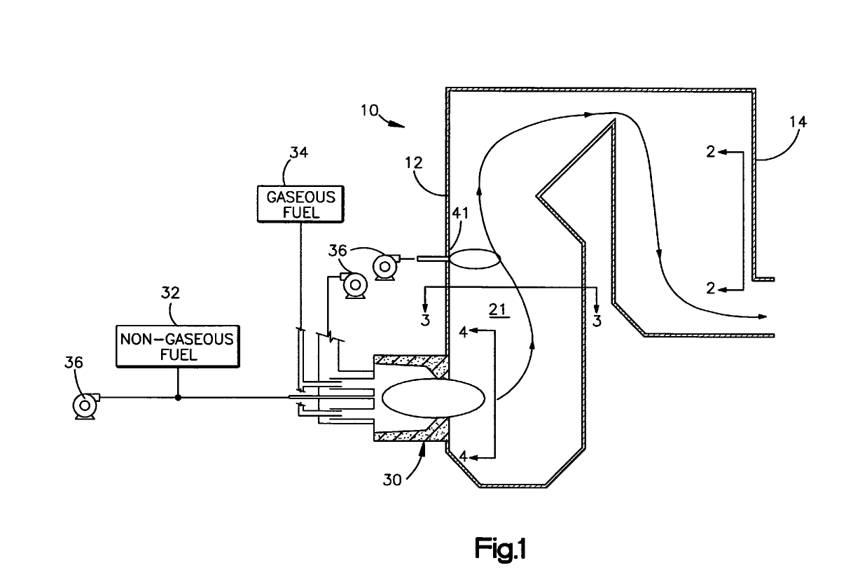

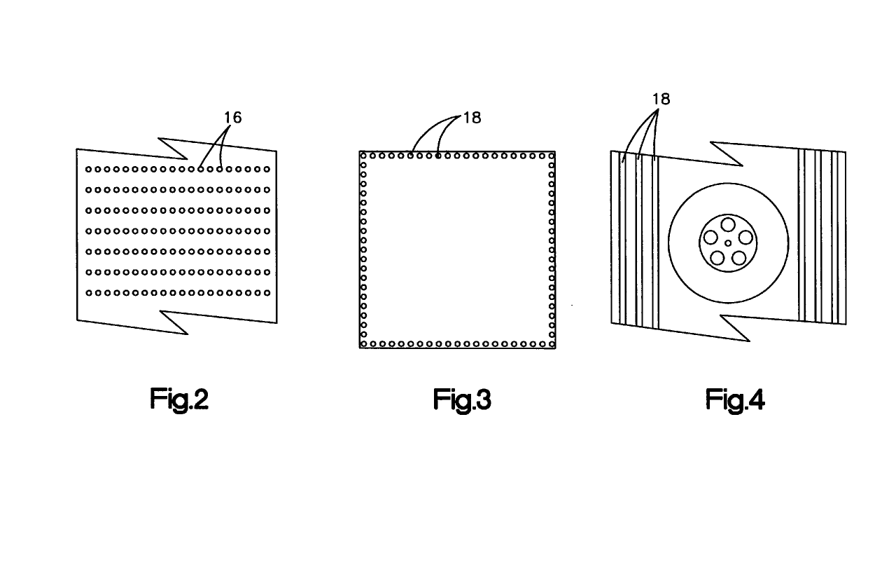

FIG. 2 is a view taken on line 4-4 of FIG. 1, showing additional parts of the boiler.

FIG. 5 is an enlarged partial view of the boiler of FIG. 1.

FIG. 6 is a partial front view of parts shown in FIG. 5.

FIGS. 7-10 are views similar to FIG. 5, showing alternative embodiments.

FIG. 11 is a partial front view of parts shown in FIG. 10.

FIGS. 12 and 13 are views of other alternative embodiments.

FIG. 14 is a partial front view of parts shown in FIG. 13.

FIG. 15 is a view of another alternative embodiment.

FIG. 16 is a partial front view of parts shown in FIG. 15.

FIGS. 17-19 are views of other alternative embodiments.

FIG. 20 is a view of another alternative embodiment.

FIGS. 21 and 22 also are views other alternative embodiments.

### DETAILED DESCRIPTION

The invention provides a method of delivering non-gaseous fuel to an industrial combustion process using premix, which is a mixture of oxidant and gaseous fuel. For the case of solid fuels, premix can be used as the conveyance means instead of conveyance air; for the case of liquid fuels, premix can be used as an atomizing medium. Alternatively, premix can be injected separately from the non-gaseous fuel stream(s) in one or more adjacent streams or in ported, annular, or arcuate arrangements surrounding the solid fuel delivery port.

A preferred result of the invention is to establish an initial, local, high reaction rate zone upon ignition of the premix which maximizes the volatilization rate of the non-gaseous fuel. It has been shown that high temperature volatilization increases volatile yield and reduces char, thereby diminishing the nitrogen content of the char and reducing the amount of fuel NOx produced from the combustion of the non-gaseous fuel.

This invention seeks to inhibit NOx formation from the combustion of the non-gaseous fuels due to the fuel NOx pathway, but it can also inhibit the thermal NOx pathway. Liquid and solid fuels used in industrial combustion commonly contain non-trivial concentrations of nitrogen atoms which are chemically bound to other atoms in the fuel; it is well known that although much of such nitrogen in these fuels, upon liberation from chemical bonds (usually to carbon and/or hydrogen atoms) and radicalization, combine with other nitrogen radicals to form diatomic nitrogen (N2), a portion of the nitrogen radicals react with oxygen radicals to form nitric oxide (NO).

Recent research (by others) has indicated that localized high heat release zones obtained via oxygen injection, though potentially increasing thermal NOx, can reduce fuel NOx because alternate reaction kinetics become favorable. Due to the complex organic molecules typically present in liquid and solid fuels, the volatilization and reaction time is on the order of tens of milliseconds (10⁻² seconds).

For premix combustion, ignition delay is on the order of a millisecond (10⁻³ seconds), and reaction time is on the order of a microsecond (10⁻⁶ seconds); thus, the invention makes it possible to achieve regions of higher reaction rate (and hence higher heat release) in the presence of premix than for oxygen injection. Liquid fuels are typically atomized, forming tiny liquid droplets, to increase the surface area of the liquid stream and increase vaporization rate since the fuel reacts with oxidant essentially only in the gaseous phase. The atomizing media is typically compressed air or steam; however, one embodiment of this invention would utilize a gaseous fuel-air premix as the atomizing media instead. Since the premix would ignite both at a lower temperature and not have to undergo the vaporization step required of the liquid fuel, the premix would begin reacting sooner and at a faster rate than if the liquid fuel were atomized conventionally. Thus, using premix for atomization of the liquid fuel can create a region of high heat release early in the process, leading to less production of fuel NOx.

Solid fuels are typically delivered to a combustion process as particles suspended in a stream of conveyance air. The conveyance air is typically significantly less than that required for stoichiometric combustion of the solid fuel, and additional combustion air is added in the proximity of the solid fuel/conveyance air outlet. When the solid fuel is exposed to high temperature (as in a combustion chamber), a portion of the species therein volatilize and become gaseous. It is these gaseous species which subsequently combust with the conveyance and combustion air. Therefore, in another embodiment of the invention, the conveyance air is replaced with a stream of gaseous fuel-air premix. Since the premix would ignite both at a lower temperature and not have to undergo the volatilization step required of the solid fuel, the premix would begin reacting sooner and at a faster rate than if the solid fuel were conveyed conventionally. Thus, using premix for conveyance of the solid fuel can create a region of high heat release early in the process, leading to reduced production of fuel NOx.

Oxygen injection requires an operationally expensive onsite source of high-purity oxygen, the associated infrastructure to deliver the oxygen to the combustion chamber, and the additional means of injection. From a design standpoint, significant trial and error may be required to arrive at an oxygen injection configuration (injection angle, velocity, etc.) for suitable fuel NOx reduction.

When oxygen combustion is employed, some amount of fuel is burned at extremely high flame temperatures, potentially in a region of where substantial O2 is present. This can lead to a super-equilibra of O atoms and substantial thermal NOx production. By using a volume of air/fuel gas premix, the interface between the combustion air stream and the non-gaseous fuel can essentially be “engineered”. This means that specific temperatures and oxygen concentrations can be achieved to best release the nitrogen from the fuel, limiting fuel NOx, while not creating excessive levels of thermal NOx.

In an oxy-boost or oxy-combustion environment, initial reaction of O2 with the fuel will occur at flame temperatures near 5000 F. While great for volatilization of the fuel, this is clearly a temperature region where substantial thermal NOx is created. Using a premix “buffer” between the non-gaseous fuel and the combustion air stream in accordance with the invention, one can select the proper premix ratio to achieve desired results. For instance, the premix can be designed to react at 2500 F, producing little to no thermal NOx in its own reaction, but providing substantial heat for the volatilization of the non-gaseous fuel along with a limited amount of oxygen (approx. 9% O2) in the premix products. Since the premix reaction occurs rapidly compared to other chemical processes in these flames, a specific temperature and oxygen profile can be engineered by selecting appropriate premix volumes and fuel/air ratio. These in turn will determine the reaction temperature, premix product gas O2 content and the percentage of non-gaseous fuel combusted with the premix product gas.

The addition of combustion products early in the combustion zone further aid in minimizing thermal NOx produced downstream, as the products reduce the local oxygen concentrations.

A preferred embodiment of the invention injects a stream of gaseous fuel/air premix into a combustion zone adjacent to a stream of solid fuel and conveyance air. The stream of premix shields the solid fuel from combustion air in a region of reacting premix, thus further heating the solid fuel and increasing the rate of volatilization. Further, since the combustion of the fuel in the premix consumes oxygen, it creates a region of locally low oxygen concentration which, instead of promoting the production of NOx, favors the recombination of nitrogen radicals into diatomic nitrogen (N2) as the solid fuel interacts with the combusting premix.

The utilization of premix in combination with non-gaseous fuels creates a favorable thermochemical environment for the fuel-bound nitrogen to recombine with other nitrogen to form diatomic (N2) nitrogen instead of forming NOx, and can do so while avoiding the drawbacks of using an increased oxygen oxidant. Such drawbacks include ultra-high flame temperature, locally high oxygen concentration, associated thermal NOx creation, high capital and operating cost, and limited flexibility.

The premix can be varied across a range of fuel/air ratios, which can be specifically selected based on the volatilization characteristics of the non-gaseous fuel. Additionally, premix has more flexibility to create a favorable environment for nitrogen recombination since it can provide a range of the heat required by the process.

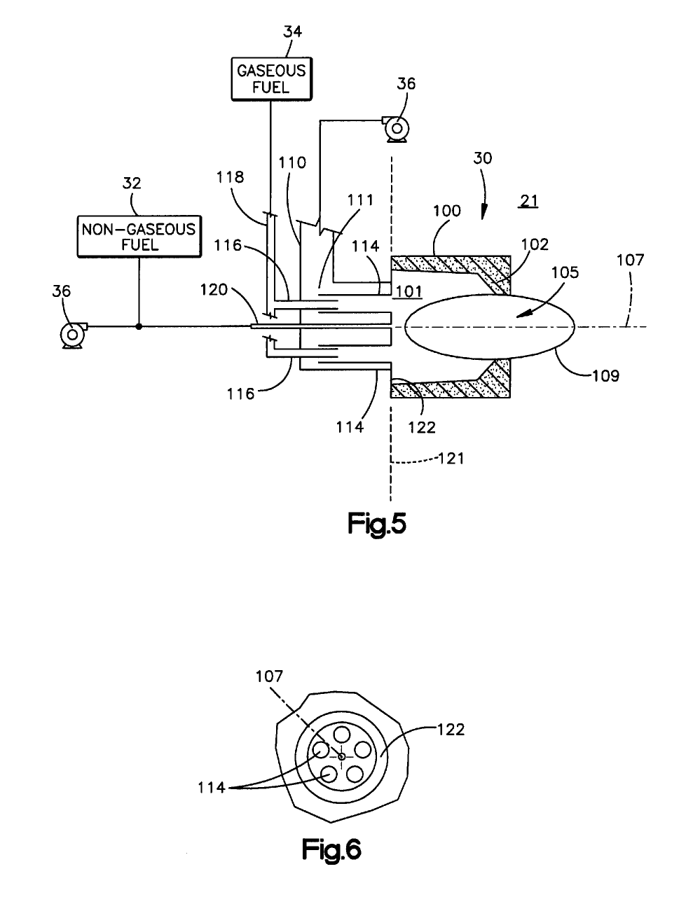

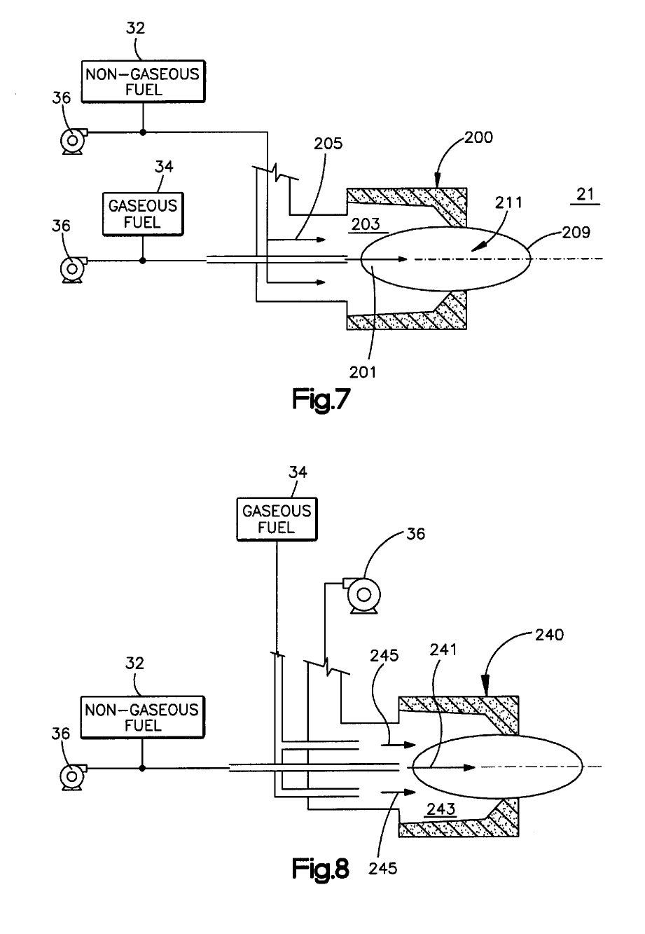

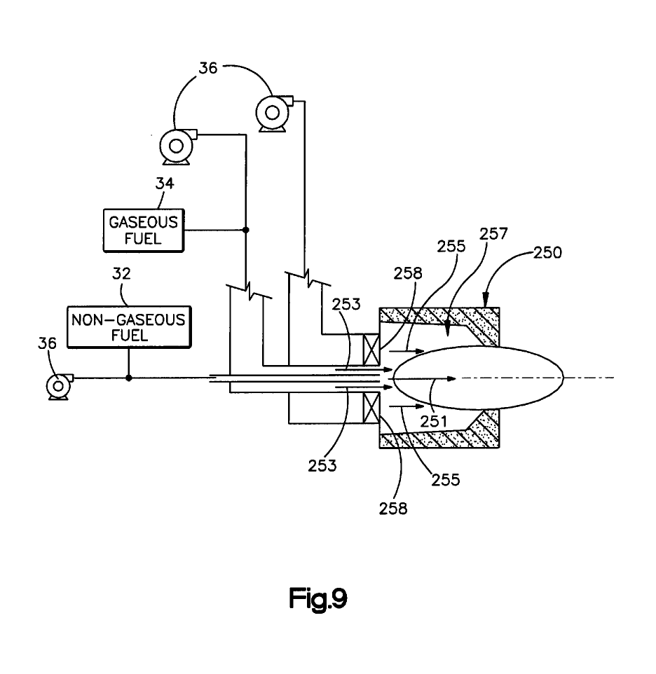

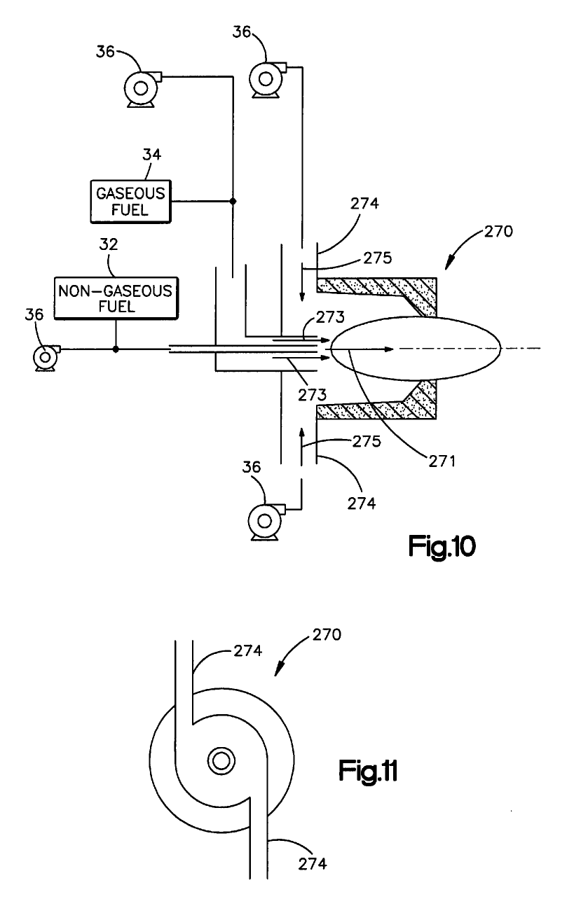

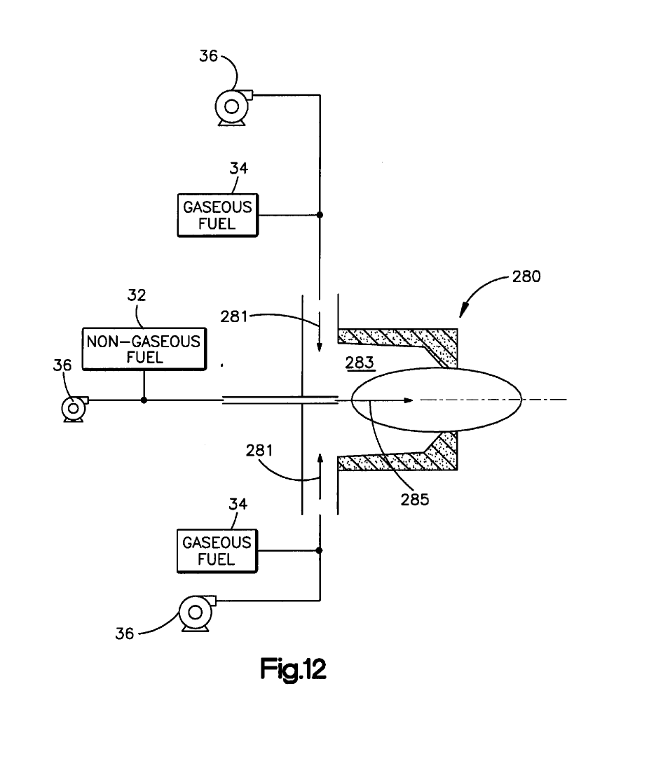

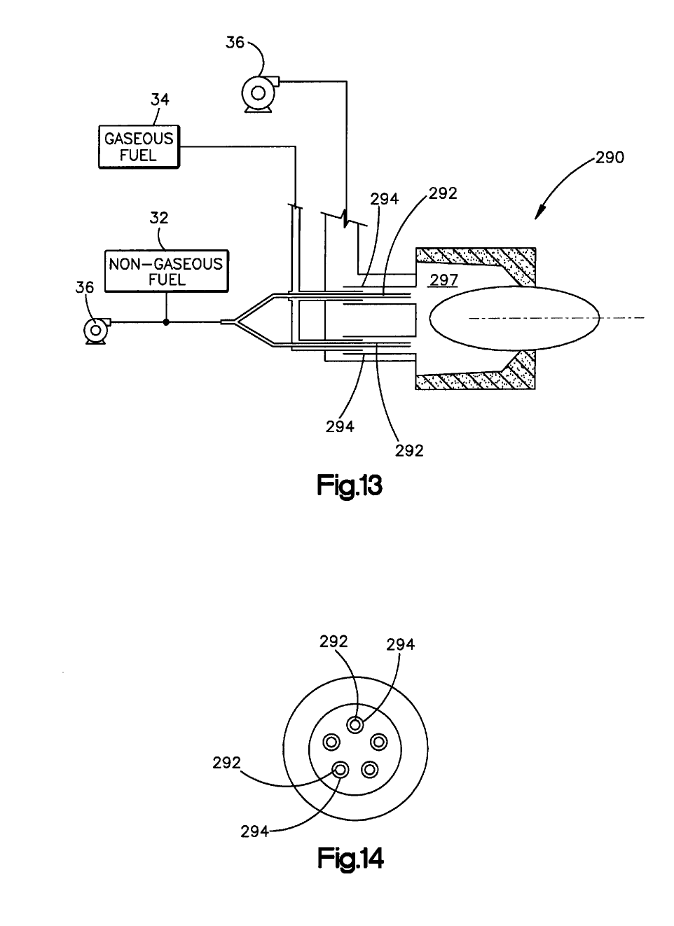

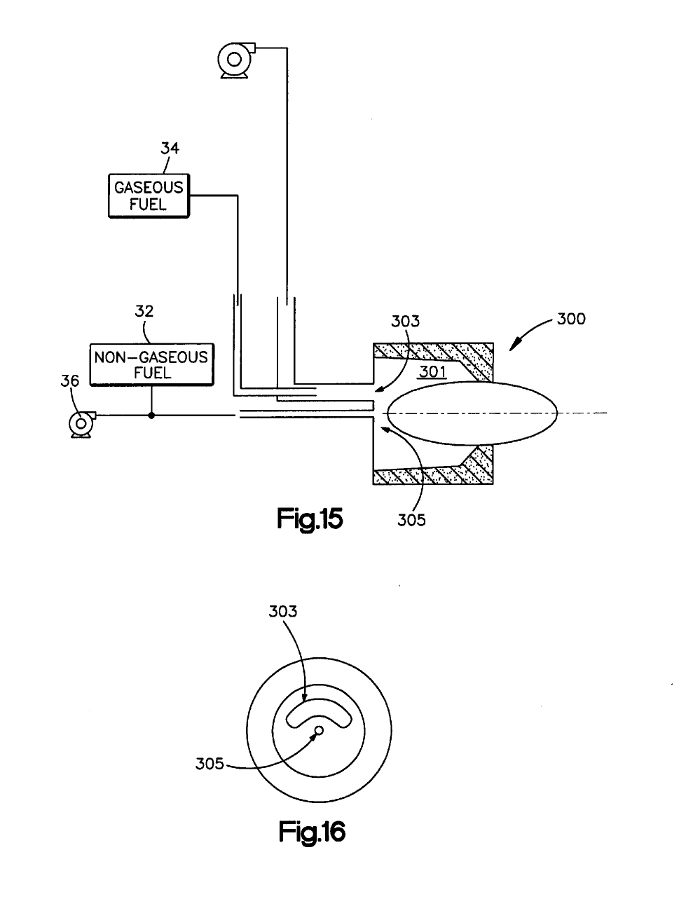

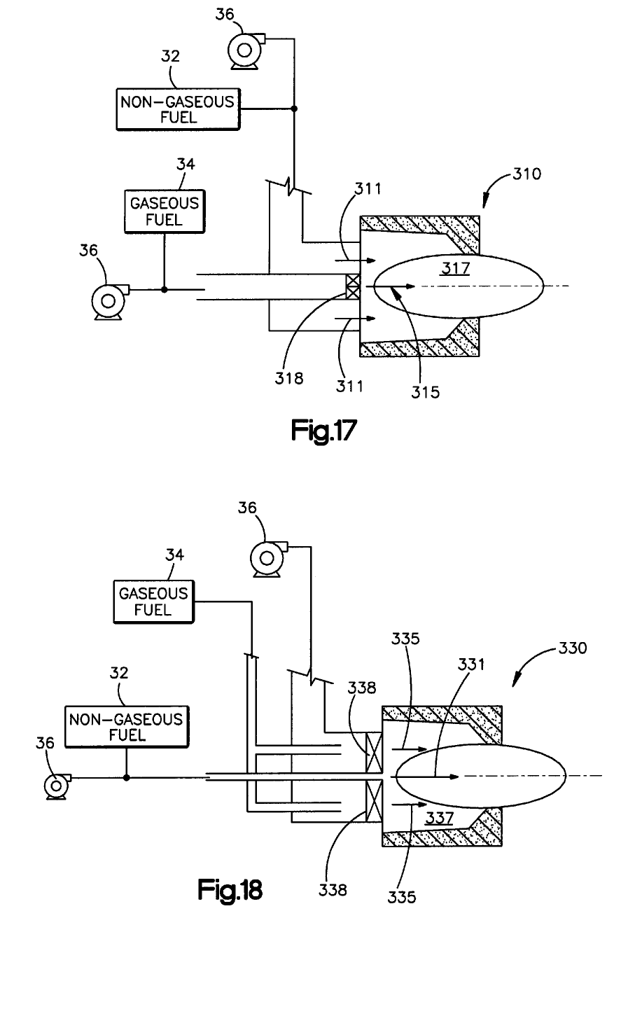

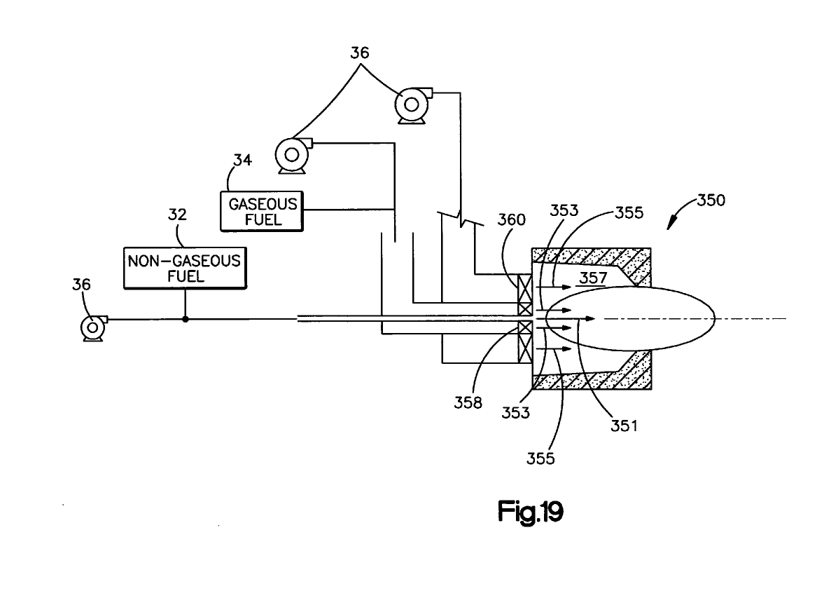

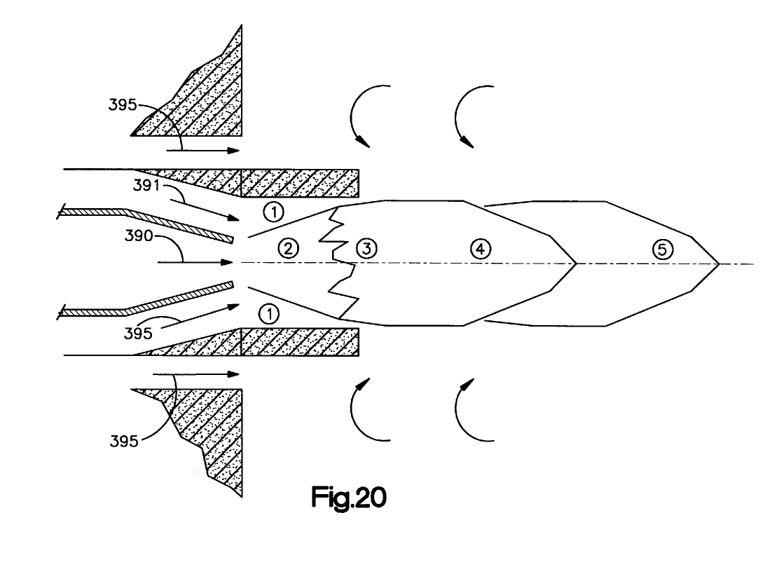

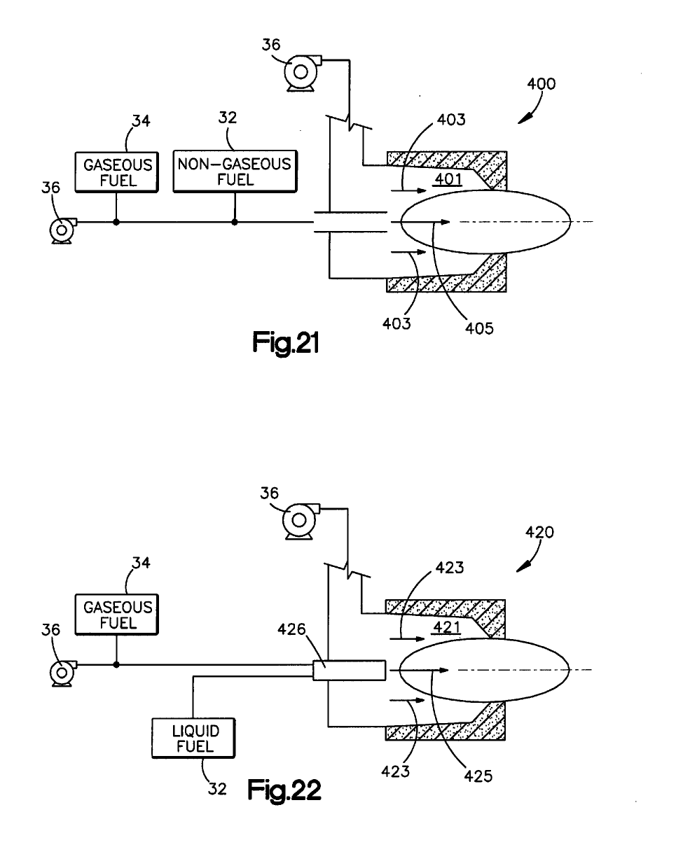

FIG. 1 is a schematic illustration of a field-erected boiler 10 that is used to create steam in an electricity-generating power plant by combusting fuel to heat liquid water. The two main portions of the boiler 10 are the firebox 12 and the convection pass 14. Inside a series of circular tubes 16 (FIG. 2), water is first directed through the convection pass 14 where the tubes 16 fill most of the rectangular cross-section, though there is some space in between the tubes 16. After the convection pass 14, the water is routed to a series of adjacent tubes 18 (FIG. 3) along the walls of the firebox 12. After leaving the firebox 12, the water, now in the form of gaseous steam, continues to a turbine where it is used to generate electricity.

The firebox 12, which is sometimes referred to as the furnace, defines a process chamber 21 in which the heat of combustion is used to do work. In the given example the process chamber 21 is rectangular in cross-section, and is connected to a burner 30, which itself is connected to sources of non-gaseous fuel 32 and gaseous fuel 34. A blower system 36 provides the burner 30 with primary combustion air. Suitable non-gaseous fuels include coal, biomass and fuel oil. In this embodiment, solid fuels would be delivered to the burner 30 with a stream of conveyance air, but liquid fuels would not.

The non-gaseous fuel in the illustrated example is pulverized coal that is transported in suspension by a relatively small quantity of flowing conveyance air. The conveyance air is preferably about 10% of that required for stoichiometric combustion of the non-gaseous fuel. The non-gaseous fuel contains about 90% of the heat input into the boiler 10. The gaseous fuel, which is preferably natural gas, contains the balance of the heat input delivered to the boiler 10.

The non-gaseous fuel, gaseous fuel, and combustion air provided through the burner 30 combust in the firebox 12, creating high temperature products of combustion (POC) which flow generally upward through the firebox 12. A source of secondary oxidant, which in the illustrated example is a port 41 through which secondary combustion air is delivered from the blower system 36, is located above the burner 30. In other examples, the source of secondary oxidant could include a lean premix of gaseous fuel and air, exhaust from a gas turbine, recirculated flue gas, or any other available source of oxygen. The secondary oxidant provides the balance of the oxygen which is required to complete combustion of the gaseous and non-gaseous fuels. The high temperature POC transfer heat to the water tubes 18 via radiant and convective heat transfer modes in the firebox 12 before proceeding through the convection pass 14, where they continue to transfer heat to the water tubes 16 in that portion of the boiler 10 primarily via convective heat transfer. After traveling through the convection pass 14, the POC go to a stack where they are discharged outside of the power plant and into the atmosphere.

The burner 30 in the example of FIG. 1 shown separately in FIGS. 5 and 6. This embodiment of the burner 30 includes a refractory structure 100 defining a combustion chamber 101. An open outer end portion 102 of the refractory structure 100 defines a burner port 105 centered on an axis 107. The outer end portion 102 is internally tapered for stabilizing a flame 109 projecting outward through the burner port 105 from the combustion chamber 101 into the process chamber 21.

A duct structure 110 at the rear of the refractory structure 100 defines a combustion air plenum 111. A group of mixer tubes 114 communicate the plenum 111 with the combustion chamber 101, and are arranged in a circular array centered on the axis 107. A corresponding group of branch lines 116 extend from a gaseous fuel supply line 118 into the mixer tubes 114. A non-gaseous fuel supply line 120 extends along the axis 107 to the combustion chamber 101. In this example, the outlet ports of the mixer tubes 114 and the non-gaseous fuel line 120 are located in a common plane 121 on a wall 122 facing axially into the combustion chamber 101 at the rear end of the combustion chamber 101.

In this configuration, the non-gaseous fuel supply line 120 delivers a stream of coal and conveyance air into the combustion chamber 101 along the axis 107. The mixer tubes 114 receive streams of primary combustion air from the plenum 111, and also receive streams of gaseous fuel from the branch lines 116. Those reactants form a fuel-air premix as they flow along the mixer tubes 114. The premix in this example is the source of primary combustion air, and is injected into the reaction chamber 101 in a circular array of streams that surround, and are adjacent to, the axially centered stream of coal and conveyance air. Combustion of all these reactants produces the flame 109 that projects outward through the burner port 105 from the combustion chamber 101 to the process chamber 21.

FIGS. 7-19 show alternative embodiments the burner. In the burner 200 of FIG. 7, an axially centered stream 201 of premix is injected into the combustion chamber 203 surrounded by an annular stream 205 of coal and conveyance air. These reactant streams produce a flame 209 that projects through the burner port 211 from the combustion chamber 203 to the process chamber 21.

In the burner 240 of FIG. 8, an axially centered stream 241 of coal and conveyance air is injected into the combustion chamber 243 surrounded by an annular stream of premix 245.

In the burner 250 of FIG. 9, an axially centered stream 251 of coal and conveyance air is surrounded by an annular stream 253 of premix. The annular stream 253 of premix is surrounded by an annular stream of primary combustion air 255 that enters the combustion chamber 257 through swirling vanes 258.

In the burner 270 of FIGS. 10 and 11, an axially centered stream of coal and conveyance air 271 is surrounded by an annular stream 273 of premix. Tangentially oriented ducts 274 convey streams 275 of secondary combustion air radially inward to form a vortex surrounding the annular stream 273 of premix.

In the burner 280 of FIG. 12, tangentially delivered streams 281 of premix enter the combustion chamber 283 as a vortex surrounding an axially centered stream 285 of coal and conveyance air.

In the burner 290 of FIGS. 13 and 14, non-gaseous fuel branch lines 292 extend through mixer tubes 294 to inject streams of coal and conveyance air into the reaction chamber 297. Each stream of coal and conveyance air injected from a non-gaseous fuel branch line 292 is surrounded by a stream of premix emerging from the respective mixer tube 294.

In the burner 300 of FIGS. 15 and 16, premix is injected into the combustion chamber 301 through an arcuate premix port 303 located above the non-gaseous fuel port 305.

In the burner 310 of FIG. 17, an annular stream 311 of coal and conveyance air surrounds an axially centered stream 315 of premix that enters the combustion chamber 317 through swirling vanes 318.

In the burner 330 of FIG. 18, an axially centered stream 331 of coal and conveyance air is surrounded by an annular stream 335 of premix that enters the combustion chamber 337 through swirling vanes 338.

In the burner 350 of FIG. 19, an axially centered stream 351 of coal and conveyance air is surrounded by concentric annular streams 353 and 355 of premix and secondary air that enter the reaction chamber 357 through respective swirling vanes 358 and 360.

In each embodiment of the invention, the intention is to separate the non-gaseous fuel from the combustion air until the volatilization of the non-gaseous fuel and the recombination of the nitrogen is complete or nearly complete. In the embodiments shown as examples in FIGS. 1-20, this is accomplished by injecting a stream of premix into the combustion zone adjacent to the stream of non-gaseous fuel and conveyance air. By “adjacent” it is meant that no other reactant stream is injected into the combustion zone between the adjacent streams. This enables the stream of premix to adjoin, mix and interact with the stream of non-gaseous fuel and conveyance air before the combustion air can have the undesirable cooling and NOx producing effects noted above. The ports from which the adjacent streams are injected into the combustion zone are likewise adjacent to each other, and in some examples are as close together as their structures will allow. In those examples, the adjacent streams are initially separated only by the structure of their respective ports, and are thus injected into the combustion zone so as to adjoin and interact with each other as soon as possible upon entering the combustion zone.

In FIG. 20, an axially centered stream 390 of non-gaseous fuel is surrounded by an annular stream 391 of premix. An annular stream 395 of combustion air is located radially outward.

Zone 1 indicates the location where the premix combustion initiates.

Zone 2 indicates where the combusting premix mixes with the solid fuel stream, causing the particles to heat up.

Zone 3 indicates where the particles have been heated sufficiently to begin releasing volatile species in a gaseous phase, which subsequently begin combusting.

Providing a zone 1 of combusting premix at a location adjoining zones 2 and 3 reduces the time, and thus distance, required to heat the particles and initiate volatilization, in essence moving the end of zone 3 and beginning of zone 4 closer to the point of injection of the solid fuel (toward the left in FIG. 20) as compared to not providing such a zone 1 of combusting premix.

Zone 4 is the high temperature/low oxygen zone which greatly promotes recombination of nitrogen radicals because of the lower concentration of oxygen radicals available for the production of NOx.

Zone 5 indicates the where the completion of combustion occurs as the air mixes with the combination of the premix and solid fuel and their respective products of combustion formed thus far.

In the burner 400 of FIG. 21, combustion air is injected into the combustion chamber 401 as an annular stream 403 surrounding an axially centered reactant stream 405. The axially centered reactant stream 405 contains solid fuel, and contains gaseous fuel/air premix as the conveyance medium for the solid fuel.

In the burner 420 of FIG. 22, combustion air is injected into the combustion chamber 421 as an annular stream 423 surrounding an axially centered reactant stream 425 injected from an atomizing nozzle 426. The axially centered reactant stream 425 contains liquid fuel, and contains gaseous fuel/air premix as an atomizing medium.

This written description sets forth the best mode of the invention, and describes the invention so as to enable a person of ordinary skill in the art to make and use the invention, by presenting examples of the elements recited in the claims. The patentable scope of the invention is defined by the claims, and may include other examples that occur to those skilled in the art. Such other examples are intended to be within the scope of the claims if they have elements that do not differ from the literal language of the claims, or if they have equivalent elements with insubstantial differences from the literal language of the claims.

1. A method comprising:
providing a load to be heated in a process chamber;
providing a first reactant stream including non-gaseous fuel;
injecting the first reactant stream into a combustion chamber that communicates with the process chamber through a burner port;
causing the non-gaseous fuel to volatilize in the combustion chamber;
providing a second reactant stream including a premix of gaseous fuel and primary oxidant;
injecting the second reactant stream into the combustion chamber adjacent to the first reactant stream to cause the second reactant stream to adjoin the first reactant stream at a region of volatilization of the non-gaseous fuel;
causing the first and second reactant streams to combust together and yield products of combustion in the combustion chamber; and
directing the products of combustion through the burner port from the combustion chamber to the process chamber.

2. A method as defined in claim 1 further comprising the steps of providing a third reactant stream including secondary oxidant, and injecting the third reactant stream into the process chamber from a port spaced from the burner port.

3. A method as defined in claim 2 wherein the secondary oxidant is atmospheric air.

4. A method as defined in claim 1 further comprising the steps of providing additional reactant streams, each of which includes gaseous fuel/air premix, and injecting the additional reactant streams into the combustion chamber adjacent to the first reactant stream to cause each of the additional reactant streams to adjoin the first reactant stream at a region of volatilization of the non-gaseous fuel.

5. A method as defined in claim 4 wherein the additional reactant streams are injected into the combustion chamber in a circular array surrounding the first reactant stream.

6. A method as defined in claim 1 wherein the first reactant stream is injected into the combustion chamber in an annular configuration surrounding the second reactant stream.

7. A method as defined in claim 6 wherein the second reactant stream is injected into the combustion chamber in a swirl.

8. A method as defined in claim 1 wherein the second reactant stream is injected into the combustion chamber in an annular configuration surrounding the first reactant stream.

9. A method as defined in claim 8 wherein the second reactant stream is injected into the combustion chamber in a swirl.

10. A method as defined in claim 1 further comprising the steps of providing a third reactant stream including secondary oxidant, and injecting the third reactant stream into the combustion chamber, with the second reactant stream interposed between the first and third reactant streams.

11. A method as defined in claim 10 wherein the secondary oxidant is atmospheric air.

12. A method as defined in claim 10 wherein the third reactant stream is injected into the combustion chamber in an annular configuration surrounding the first and second reactant streams.

13. A method as defined in claim 10 wherein the third reactant stream is injected into the combustion chamber in a swirl.

14. A method as defined in claim 1 wherein the step of providing the first reactant stream provides a plurality of reactant streams including non-gaseous fuel, the step of providing the second reactant stream provides a plurality of reactant streams including gaseous fuel/air premix, and each of the plurality of reactant streams of gaseous fuel/air premix is injected into the combustion chamber in an annular configuration surrounding a corresponding one of the plurality of reactant streams of non-gaseous fuel.

15. A method as defined in claim 1 wherein the second reactant stream is injected into the combustion chamber in an arcuate configuration extending partially around the first reactant stream.

16. A method comprising:
providing a load to be heated in a process chamber;
providing a reactant stream including solid fuel and gaseous fuel/air premix as a conveyance medium for the solid fuel;
injecting the reactant stream into a combustion chamber that communicates with the process chamber through a burner port;
causing the solid fuel to volatilize in the combustion chamber;
causing the solid fuel and the premix to combust together and yield products of combustion in the combustion chamber; and
directing the products of combustion through the burner port from the combustion chamber to the process chamber.

17. A method as defined in claim 16 wherein the premix includes the air as primary oxidant, and further comprising the steps of providing an additional reactant stream including secondary oxidant, and injecting the additional reactant stream into the process chamber from a port spaced from the burner port.

18. A method comprising:
providing a load to be heated in a process chamber;
providing a reactant stream including liquid fuel and gaseous fuel/air premix as an atomizing medium for the liquid fuel;
injecting the reactant stream into a combustion chamber that communicates with the process chamber through a burner port;
causing the liquid fuel to volatilize in the combustion chamber;
causing the liquid fuel and the premix to combust together and yield products of combustion in the combustion chamber; and
directing the products of combustion through the burner port from the combustion chamber to the process chamber.

19. A method as defined in claim 18 wherein the premix includes the air as primary oxidant, and further comprising the steps of providing an additional reactant stream including secondary oxidant, and injecting the additional reactant stream into the process chamber from a port spaced from the burner port.
